(19) United States
(12) Patent Application Publication
(10) Pub. No.: US 2006/0015895 A1
(43) Pub. Date: Jan. 19, 2006

(54) Method and system for avoiding undesirable portions of a recorded audiovisual program

(76) Inventor: Christopher J. Stone, Newtown, PA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/881,387

(22) Filed: Jun. 30, 2004

(51) Int. Cl. H04N 7/025; H04N 5/91; H04N 7/26; H04N 7/10

(52) U.S. Cl. 725/32; 386/110; 386/68; 725/36

(57) ABSTRACT

A method and system for avoiding undesirable portions of a recorded audiovisual program includes generating a data set indicating portions of the audiovisual program avoided by previous viewers and automatically avoiding those portions of the audiovisual program during subsequent replay using the data set.

### BACKGROUND

A major leisure and educational activity in modern society is watching broadcast television programming. Most homes include a television set for watching broadcast programming. This programming may be received by terrestrial broadcast, cable network, satellite system, computer network, etc.

Frequently, a program that a viewer wants to watch may be broadcast at a time that is inconvenient for the viewer to be watching. In other cases, a viewer may wish to watch a program repeatedly.

To address these situations, devices have been developed that allow a viewer to record broadcast programming so that the programming can be watched repeatedly or at a more convenient time. Video cassette recorders (VCRs) were the first examples of such recording devices. The most recent such devices are known as Digital Video Recorders (DVRs) or Personal Video Recorders (PVRs). These devices typically include a hard-drive or other mass data storage unit that can digitally store a large volume of audiovisual programming data.

Typically, broadcast television programming includes commercial interruptions that are interspersed throughout the programming. During these commercial breaks, the program being broadcast is interrupted by a message from an advertiser or a program sponsor. Such interruptions are frequently considered an annoyance by the viewer watching the programming, particularly if the viewer has no interest in the product or service being advertised.

If the programming is being watched lived, the viewer typically has no choice but to endure the commercial break until the program being watched resumes. If the viewer is watching a recorded program, the viewer can fast-forward through the recorded video when a commercial break occurs and, at least, decrease the time during which enjoyment of the program is interrupted.

However, such fast-forwarding requires the viewer to expend time and effort actively operating the video recorder so as to fast-forward through the commercial break. The viewer may also overshoot the end of the commercial break and end up fast-forwarding through a portion of the recorded program that the viewer wises to see. Some viewers may then spend time rewinding the recorded program to the end of the commercial break. Consequently, even when watching recorded programming, it is difficult for such interspersed commercial breaks to not have a negative impact on the viewing of the recorded program.

### SUMMARY

A method and system for avoiding undesirable portions of a recorded audiovisual program includes generating a data set indicating portions of the audiovisual program avoided by previous viewers and automatically avoiding those portions of the audiovisual program during subsequent replay using the data set.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 illustrates a system of video recorders that communicate with a central database to share data on skipping over commercial breaks or other interruptions or objectionable material in recorded programming.

FIG. 2 illustrates a recorded program for which a number of portions will be automatically skipped during playback based on data collected from the playback of the same program with other video recorders.

FIG. 3 is a flowchart illustrating a method of automatically editing commercial breaks or other interruptions or objectionable content from the replay of a recorded program.

Throughout the drawings, identical reference numbers designate similar, but not necessarily identical, elements.

### DETAILED DESCRIPTION

The typical viewer who records a television program will fast-forward and/or skip through commercial breaks or other interruptions or objectionable content when replaying the recorded program. By collecting data on the fast-forwarding or skip actions made by previous viewers replaying a program, a data set can be created that indicates where the commercial breaks or other interruptions are in that program. Consequently, a recorder receiving that data set can automatically skip those interruptions during playback of the program based on the actions of the previous viewers. In this way, the annoying interruptions or objectionable scenes are automatically skipped without the current viewer having to take any action.

As used in this specification and the attached claims, “audiovisual programming” refers to any audio or audiovisual program, such as broadcast television programming. “Recorder” refers broadly to any audiovisual or video recording device, such as a DVR, PVR, VCR, and the like. “Interruption” will be used to refer broadly and collectively to content in an audiovisual recording that a viewer may want to skip, for example, commercial breaks, objectionable scenes or other interruptions.

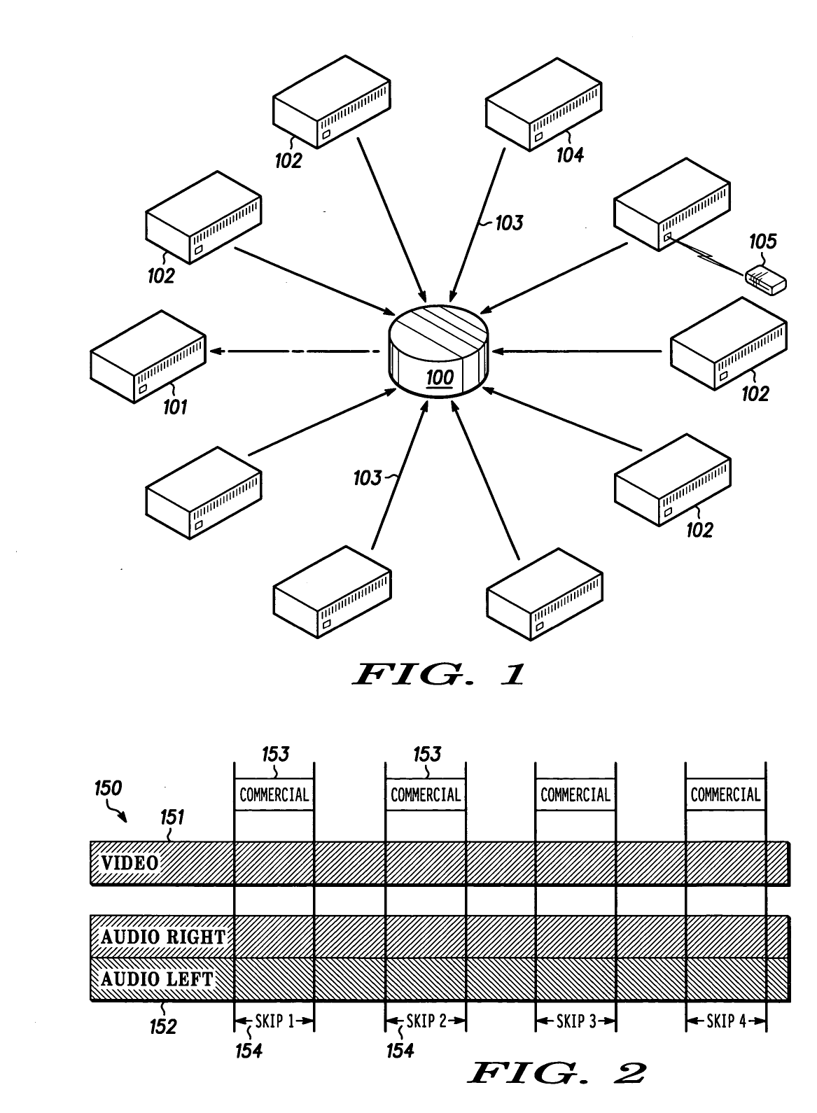

FIG. 1 illustrates a system of video recorders that communicate with a central database to share data on commercial breaks or other interruptions that a viewer will want to avoid in recorded programming. As shown in FIG. 1, a population of recorders (102), for example, digital video recorders (DVRs), is in communication with a central database (100).

The links (103) between the recorders (102) and the database (100) can be any data-bearing link, such as a telephone line, a cable network, a wireless network, the Internet or other computer network, etc. The links (103) are two-way links allowing each recorder (102) to both send and receive data from the central database (100).

Each recorder (102) will also have a connection over which audiovisual programming, for example, commercial television programming, is received. The connection over which the recorder (102) receives audiovisual programming may be the same link (103) that connects the recorder (102) to the database (100) or a separate connection.

Under the control of a human viewer, each recorder (102) may be used to record the received audiovisual programming. As noted above, the recorder (102) may be a DVR or PVR with a hard-drive or other data storage device for digitally storing recorded audiovisual programming. With programming recorded and stored on a recorder (102), the viewer can then access and playback the recorded programming whenever desired.

When a particular program is broadcast, many, perhaps millions, of viewers may record and subsequently playback the program. In the case of commercial television programming, or other types of programming, there will likely be commercial breaks or other interruptions in the program that a viewer may not want to see. Consequently, a typical viewer will fast-forward or skip through such interruptions using the features available on the recorder (102).

On a particular recorder, a viewer may have the option to fast-forward through the video programming, meaning that the viewer may increase the speed of the playback of the video so as to move rapidly through a portion of the recorded programming that the viewer wishes not to see. Additionally or alternatively, a particular recorder may allow a viewer to make skips through a portion of recorded video programming, meaning that, upon receiving a skip command from a viewer, the recorder will discontinue the playback of the recorded programming and resume the playback of the recorded programming after skipping a specific amount of the recorded programming, 30 seconds, for example.

Depending on the particular recorder, the skipping of the specific amount of recorded programming may appear instantaneous or almost instantaneous to the viewer. Several skip commands may be entered at the same time to skip a greater amount of the recorded programming.

The fast-forward and skip commands may be entered through a user interface (104) on the recorder (102). Alternatively, the fast-forward and skip commands may be input to the recorder (102) through a remote control unit (105) that is communicating wirelessly with the recorder (102).

When a typical viewer replays a recorded program, that viewer will fast-forward and/or skip through commercial breaks or other interruptions in the program. Additionally or alternatively, a viewer may fast-forward or skip portions of the program that contain objectionable content, for example, a parent attempting to omit objectionable portions of a program that is being viewed with a child.

When a viewer takes such action, the recorder (102) will report to the central database (100), via the link (103), an identification of the program that the viewer is replaying and data indicating the portions of the program that the viewer fast-forwards through or skips over. The recorder (102) can also report to the central database if the viewer rewinds any amount of the recorded program after a fast-forward or skip operation.

Consequently, the central database (100) will contain for that program a data set that specifies the portions of the program that each viewer avoided, i.e., fast-forwarded or skipped, during playback. If multiple recorders report the actions viewers took during playback of that program, the data can be combined to provide a more accurate data set indicating portions of the program that viewers typically wanted to avoid, for example, commercial breaks or other interruptions in the program.

Thus, the central database (100) gathers data on the portions of a program that viewers have typically avoided, skipped or fast-forwarded. Then, when another connected recorder (101) is used to playback the same program, the database (100) can provide to that recorder (101) the data set specifying which portions of the program should be omitted from playback, i.e., fast-forwarded or skipped. The database (100) provides this data set using the link (103) between the recorder (101) and the database (100).

The recorder (101) can then automatically fast-forward or skip those specified portions of the program during playback. In this way, the viewer using the recorder (101) can miss those portions of the recorded program that previous viewers wanted to avoid, without that viewer having to actively control the recorder to fast-forward or skip such portions of the program.

In FIG. 1, the central database is illustrated as being a single server. However, the central database may, in some embodiments, include multiple servers, perhaps at different sites, that share information collected from the population of recorders. An example would be a typical cable television system where the network in one city or state is a physically different cable network than one in a second city or state, even though both networks are owned and operated by one company. In such a case, there would be at least two servers or central databases, one for each network, which could then share data with each other via a connection between the servers. For example, a dedicated T1 line might connect the two servers, but not the two networks. Typically, a recorder on one network would communicate only with the central database on the same network. Thus, the term “central database” as used herein and in the appended claims includes the case where one or more servers, in communication with each other and with one or more populations of recorders, share information collected from recorders regarding portions of programming avoided by viewers.

FIG. 2 illustrates a recorded program for which a number of portions will be automatically skipped during playback based on data collected from the playback of the same program with other video recorders. FIG. 2 is also a graphical representation of the data set transmitted from the database (100, FIG. 1) to a requesting recorder (101, FIG. 1) that is replaying a program for which previous viewer action has been collected.

As shown in FIG. 2, a particular audiovisual program (150) will typically include a stream of video data (151) with a corresponding stream of audio data (152). As shown in FIG. 2, the audio data (152) may be in stereo and divided into a right channel and a left channel.

The audiovisual program (150) is identified, for example, by name; broadcast time, date and channel; alphanumeric identifier; programming guide identifier or some other means. The various components of the system shown in FIG. 1 will all use the same identifier for each individual program. Consequently, as earlier viewers replay a recorded version of that particular program and avoid certain portions using the fast-forward or skip features of the recorder, their recorders can identify to the database (100, FIG. 1) the program that is being replayed along with an indication of the portions avoided. The database (100, FIG. 1) can then compare and combine the actions taken by different viewers to avoid portions of that particular program.

When a later viewer then replays a recording of that same program, the recorder (101, FIG. 1) being used to replay that program can accurately identify the program to the central database (100, FIG. 1). The recorder (101, FIG. 1) can then request the collected data for that particular program which has been compiled by monitoring previous viewers who have replayed that program.

As described above, this collected data will identify various portions in the recorded program (150) that previous viewers have taken actions to avoid, for example, commercials (153), objectionable content or other interruptions. These portions to be avoided (153) are identified (154) in the data set corresponding to that particular program so that the requesting recorder (101, FIG. 1) can automatically skip over and not replay those portions (153) of the recorded program (150).

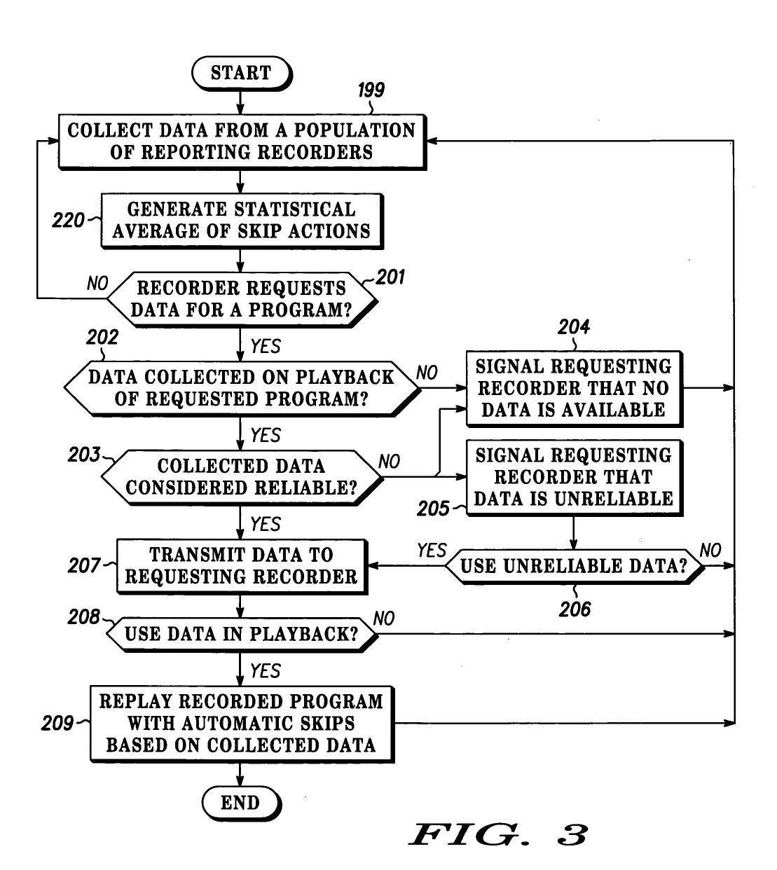

FIG. 3 is a flowchart illustrating a method of automatically editing commercial breaks, objectionable content or other interruptions from a recorded program. The method of FIG. 3 is implemented, for example, by the system illustrated and described above in FIG. 1. Thus, FIG. 3 describes, in part, firmware that controls the operation of the various recorders (101, 102; FIG. 1) illustrated in FIG. 1.

As shown in FIG. 3, the method starts with the collection of data (step 199) from the population of reporting recorders. This data indicates actions taken by viewers to avoid portions of a particular recorded program during replay. As described above, this collection of data is performed by a central database (100, FIG. 1) that is in communication with the population of recorders (102, FIG. 1).

It is not necessary that the database individually identify different reporting recorders. However, it can be useful for the database to be able to count the number of different recorders reporting on a particular program and distinguish between the data on a particular program coming from different recorders.

In the illustrated embodiment, the database (101, FIG. 1) will generate a statistical average of actions taken by viewers to skip or avoid portions of the recorded program (step 220). This comparison and averaging of the data reported by various recorders will tend to make the final data set more representative of the portions of a recorded program that a typical viewer desires to avoid. In other words, the database (101, FIG. 1) includes logic that compares and combines, based on various analytical techniques, the reported actions users have taken to avoid portions of that program so as to fine tune a more accurate description of the portions of the program to be avoided.

For example, supposed that 100,000 recorders have reported data on the playback of a particular audiovisual program. Any analysis of this data reveals that, at approximately five minutes into the 100,000 replays of the program reported to the database, all of the reporting viewers implemented a 30 second skip and repeated the skip command four times, for a total of two minutes skipped. In 75,000 of the 100,000 reported replays, the viewers then gave a rewind command and allowed the program to rewind for an average time of three seconds.

Based on this situation, the database (101, FIG. 1) will conclude that the two minute skip implemented by the viewers went three seconds too far into the recorded program. In other words, from the point at which the viewers started entering skip commands, the portion the viewers generally wanted to avoid was two minutes, less three seconds, in length. In other words, the four consecutive skip commands took the viewer three seconds too far into the recorded program. 25,000 of the viewers did not care about missing the three seconds overshot by the skip commands, and the other 75,000 reporting viewers attempted to correct the over-shoot by using the rewind feature.

In this example, the database would conclude that one minute, 57 seconds of the recorded program should be skipped from the point at which the reporting viewers started entering the skip commands. The point at which the reporting viewers started entering the skip commands may also be averaged so as to most accurately pinpoint the start of the content to be avoided.

The database will then subsequently instruct requesting recorders to skip one minute, 57 seconds at that point in replay of that program. Consequently, subsequent viewers will benefit from the monitoring of the actions of the previous 100,000 viewers who have replayed a recorded version of that program.

This is just one example of how the database (101, FIG. 1) can use the data from a number of reporting recorders to generate a more accurate indication of the portions of a particular program to be skipped in subsequent replays. Any such comparisons or analyses may be included or implemented in various embodiments of systems that operate according to the principles described herein.

Additionally, the database (101, FIG. 1) may have features to insure the security or reliability of the data collected before beginning to report that data to subsequent requesting recorders. This will be described in more detail below.

Returning to FIG. 3, after any comparisons or analyses have been conducted to generate a more accurate description of the portions of a program to be avoided, the data set for that program is stored in the database (100, FIG. 1) until it is requested by a recorder (101, FIG. 1) that is subsequently replaying the same program (determination 201). In some embodiments, the recorder, upon receiving a viewer command to replay a particular program, may automatically query the database for a data set identifying portions of that program to be avoided. In other embodiments, the viewer may direct the recorder to query the database for the data set corresponding to the program being replayed. The recorder may include a default setting that allows a viewer to specify whether the recorder should automatically query the database for a data set whenever a program is replayed or wait for a viewer command to query the database.

For some programs being replayed, there may be no data collected on previous replays of that program (determination 202). This will be the case immediately after a particular program has been broadcast. If no data set has been compiled for a particular program, the database cannot advise a requesting recorder as to which portions of the program to avoid. The database will then signal to the requesting recorder that no data is available for that particular program (step 204). The database will then return to collecting data whenever that program is replayed by a reporting recorder (step 199). The recorder may also display a message for the viewer indicating that no data is available specifying the portions of that program that previous viewers have avoided.

If a data set is available, it may be further evaluated for reliability (determination 203) before being distributed to requesting recorders. For example, the database may require a minimum number of similar reports on previous replays of a particular program before the results are considered reliable for editing subsequent replays of the program. Until the minimum number is satisfied, the database may consider the collected data to be unreliable (determination 203).

There may be both a minimum number of reports and a minimum number of similar reports required before the data set is considered reliable for use by subsequent viewers. The parameters for defining “similar” reports, i.e., the tolerance between viewer actions for reports to be characterized as similar, can vary.

If the data set is considered unreliable, the database may respond to requests for the data set in at least two different ways. In some embodiments, the database may simply refuse to provide an unreliable data set to requesting recorders. The database may signal the requesting recorder that no data set is available for that program (step 204).

Alternatively, the database may signal the requesting recorder that data is available, but is not necessarily considered reliable (step 205). This message can be displayed for the viewer operating that recorder. The viewer can then determine whether to use the data set which may or may not accurately skip undesirable portions of the recorded program (determination 206). The recorded may also allow the viewer to establish a default setting that unreliable data sets are automatically refused or used.

If the requesting recorder still requests the data set, based on viewer preferences, even though the data set is unsubstantiated or not considered reliable, the database will transmit the data set to the requesting recorder (step 207). Alternatively, if the data set is considered reliable, it will be transmitted to any requested recorder upon request (step 207).

Once the data set is transmitted (step 207), in some embodiments, the recorder may display for the viewer an indication of which portions of the recorded program the data set indicates should be avoided. Such a display may resemble FIG. 2.

Once the data set is received, the viewer may be given an option whether to use the data set to edit playback of the recorded program (determination 208). This option can be governed be a default setting the user enters or decided on a program-by-program basis. If the viewer indicates that the data set is to be used in replay of the program, the recorded program is then replayed by the recorder with automatic fast-forwarding through, or skips over, the portions of the program identified by the data set received from the central database (step 209).

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A method of avoiding undesirable portions of a recorded audiovisual program, the method comprising:
generating a data set indicating portions of said audiovisual program avoided by previous viewers; and
automatically avoiding portions of said audiovisual program during replay based on said data set.

2. The method of claim 1, wherein said generating is performed by a central database communicating with a population of recorders used to replay said audiovisual program.

3. The method of claim 2, wherein said generating further comprising comparing data from a number of said recorders to generate said data set.

4. The method of claim 4, wherein said comparing comprises averaging said data from a number of said recorders to generate said data set.

5. The method of claim 2, further comprising requesting, with a recorder, said data set from said central database.

6. The method of claim 5, further comprising automatically requesting said data set when said audiovisual program is replayed by said recorder.

7. The method of claim 5, further comprising requesting said data set based on user input.

8. The method of claim 5, further comprising determining whether said data set is considered reliable.

9. The method of claim 8, further comprising indicating to said requesting recorder whether said data set is reliable.

10. The method of claim 9, further comprising using or not using said unreliable data set based on user input.

11. The method of claim 1, wherein said automatically avoiding portions of said audiovisual program during replay comprises fast-forwarding through said portions of said audiovisual program.

12. The method of claim 1, wherein said automatically avoiding portions of said audiovisual program during replay comprises skipping over said portions of said audiovisual program.

13. The method of claim 1, wherein said portions avoided by viewers comprise commercials.

14. The method of claim 1, wherein said portions avoided by viewers comprise objectionable content.

15. The method of claim 1, further comprising automatically avoiding portions of said audiovisual program during replay based on user input approving use of said data set.

16. A system for avoiding undesirable portions of a recorded audiovisual program comprising:
a population of recorders; and
a central database in communication with said recorders;
wherein
said recorders report data to said central database indicating portions of said audiovisual program avoided by previous viewers, and
said central database generates a data set indicating said portions of said audiovisual program avoided by previous viewers.

17. The system of claim 16, wherein:
said central database transmits said data set to a requesting recorder in said population; and
said requesting recorder automatically avoiding portions of said audiovisual program during replay based on said data set.

18. The system of claim 16, wherein said population of recorders communicates with said central database using phone lines.

19. The system of claim 16, wherein said population of recorders communicates with said central database using a cable network.

20. The system of claim 16, wherein said population of recorders communicate with said central database using a wireless network.

21. The system of claim 16, wherein said population of recorders communicate with said central database using a computer network.

22. The system of claim 21, wherein said computer network is the Internet.

23. The system of claim 16, wherein said central database generates said data set by comparing data from a number of said recorders.

24. The system of claim 23, wherein said comparing comprises averaging said data from a number of said recorders to generate said data set.

25. The system of claim 17, wherein said requesting recorder automatically requests said data set when said audiovisual program is replayed by said recorder.

26. The system of claim 17, wherein said requesting recorder requests said data set based on user input.

27. The system of claim 16, wherein said central database further determines when said data set is considered reliable.

28. The system of claim 27, wherein said central database signals said requesting recorder whether said data set is considered reliable.

29. The system of claim 17, wherein said recorder automatically avoids said portions of said audiovisual program during replay by fast-forwarding through said portions of said audiovisual program.

30. The system of claim 17, wherein said recorder automatically avoids said portions of said audiovisual program during replay by skipping over said portions of said audiovisual program.

31. The system of claim 16, wherein said portions avoided by viewers comprise commercials.

32. The system of claim 16, wherein said portions avoided by viewers comprise objectionable content.

33. A system for avoiding undesirable portions of a recorded audiovisual program, the method comprising:
means for generating a data set indicating portions of said audiovisual program avoided by previous viewers; and
means for automatically avoiding portions of said audiovisual program during replay based on said data set.

34. The system of claim 33, wherein said means for generating a data set comprise a central database and said means for automatically avoiding portions of said program during replay comprise a population of recorders in communication with said database.

35. An audiovisual recorder that automatically avoids undesirable portions of a recorded audiovisual program comprising:
means for connecting to a central database that provides a data set indicating portions of said audiovisual program avoided by previous viewers; and
means for automatically avoiding portions of said audiovisual program during replay based on said data set.

36. The recorder of claim 35, further comprising means for requesting said data set from said database.

37. The recorder of claim 35, wherein said means for automatically avoiding portions of said audiovisual program during replay comprise means for fast-forwarding through said portions of said audiovisual program.

38. The recorder of claim 35, wherein said means for automatically avoiding portions of said audiovisual program during replay comprise means for skipping over said portions of said audiovisual program.

39. A database configured to communicate with a population of audiovisual recorders, said database comprising:
means for receiving data from said population of recorders indicating portions of a particular audiovisual program avoided by previous viewers; and
means for generating a data set indicating portions of said audiovisual program avoided by said previous viewers.

40. The database of claim 39, further comprising means for comparing data from a number of said recorders to generate said data set.

41. The database of claim 39, further comprising means for determining whether said data set is considered reliable.

42. The database of claim 39, further comprising means for transmitting said data set to said recorders.
